(19) United States
(12) Patent Application Publication
(10) Pub. No.: US 2020/0348977 A1
(43) Pub. Date: Nov. 5, 2020

(54) RESOURCE SCHEDULING METHODS, DEVICE AND SYSTEM, AND CENTRAL SERVER

(71) Applicant: SHANGHAI SENSETIME INTELLIGENT TECHNOLOGY CO., LTD., Shanghai (CN)

(72) Inventors: Jianliang YI, Shanghai (CN); Wei ZHAO, Shanghai (CN); Shengen YAN, Shanghai (CN)

(21) Appl. No.: 16/929,187

(22) Filed: Jul. 15, 2020

Related U.S. Application Data
(63) Continuation of application No. PCT/CN2019/112844, filed on Oct. 23, 2019.

(30) Foreign Application Priority Data
Mar. 7, 2019 (CN) 201910172678.0

(51) Int. Cl. G06F 9/50; G06F 9/48

(52) U.S. Cl. CPC G06F 9/5011; G06F 9/5061; G06F 9/4843

(57) ABSTRACT

A resource control method, device and system, and a central server are provided. The method includes: receiving a first Input/Output (I/O) request sent by a client device; assigning a request number to the first I/O request based on a first number interval obtained from a central server; determining a tag of the first I/O request based on the request number of the first I/O request; and scheduling the first I/O request based on the tag of the first I/O request.

### CROSS-REFERENCE TO RELATED APPLICATIONS

The present disclosure is a U.S. continuation application of International Application No. PCT/CN2019/112844, filed on Oct. 23, 2019, which claims priority to Chinese Patent Application No. 201910172678.0, filed on Mar. 7, 2019. The content of International Application No. PCT/CN2019/112844 and Chinese Patent Application No. 201910172678.0 are incorporated herein by reference in their entireties.

### BACKGROUND

In the training of Artificial Intelligence (AI) deep learning models, multiple nodes and multiple users concurrently access to storage resources. In order to ensure the speed of model training, in addition to the performance of a Graphics Processing Unit (GPU) chip, Input/Output (I/O) performance also plays a key role. However, it is found out in practical use that the case of extremely uneven distribution of resources exists, for example, some users occupy most of I/O resources, so that the training of other users is too slow or cannot be performed, and in extreme cases, a storage system can even break down.

### SUMMARY

The present disclosure relates to resource control technologies, and in particular, to resource scheduling methods, device and system, and a central server.

Embodiments of the present disclosure provide a resource scheduling technology.

According to a first aspect of the embodiments of the present disclosure, provided is a resource scheduling method, including: receiving a first I/O request sent by a client device; assigning a request number to the first I/O request based on a first number interval obtained from a central server; determining a tag of the first I/O request based on the request number of the first I/O request; and scheduling the first I/O request based on the tag of the first I/O request.

According to a second aspect of the embodiments of the present disclosure, provided is a resource scheduling method, which is applied to a server, including: receiving a first number request sent by a first resource scheduling device, where the first number request is used for requesting a number interval for a client device; and issuing a first number interval to the first resource scheduling device based on a third number interval assigned to a second number request, where the second number request is a previous number request received by the server for the client device that is sent by a second resource scheduling device, and the first number interval is a number interval after the third number interval.

According to a third aspect of the embodiments of the present disclosure, provided is a resource scheduling device, including: a request receiving unit, configured to receive a first I/O request sent by a client device; a number interval obtaining unit, configured to assign a request number to the first I/O request based on a first number interval obtained from a central server; a tag determining unit, configured to determine a tag of the first I/O request based on the request number of the first I/O request; and a resource scheduling unit, configured to schedule the first I/O request based on the tag of the first I/O request.

According to a fourth aspect of the embodiments of the present disclosure, provided is a server, including: a request receiving unit, configured to receive a first number request sent by a first resource scheduling device, where the first number request is used for requesting a number interval for a client device; a number interval issuing unit, configured to issue a first number interval to the first resource scheduling device based on a third number interval assigned to a second number request, where the second number request is a previous number request received by the server for the client device that is sent by a second resource scheduling device, and the first number interval is a number interval after the third number interval.

According to a fifth aspect of the embodiments of the present disclosure, provided is a resource scheduling system, including: multiple resource scheduling devices and a central server, where the resource scheduling device is configured to send a first number request for requesting a number interval for a client device to the central server; the central server is configured to issue the first number interval to the resource scheduling device based on the first number request and the previous third number interval sent for the client device, where the first number interval is a number interval after the third number interval.

According to a sixth aspect of the embodiments of the present disclosure, provided is an electronic device, including: a memory, configured to store executable instructions; and a processor, configured to communicate with the memory to execute the executable instructions so as to complete the operations of the resource scheduling method according to the foregoing first aspect or second aspect.

According to a seventh aspect of the embodiments of the present disclosure, provided is a computer readable storage medium, configured to store computer readable instructions, where when the instructions are executed, the operations of the resource scheduling methods according to any one of the above are executed.

According to an eighth aspect of the embodiments of the present disclosure, provided is a computer program product, including computer readable codes, where when the computer readable codes are run on a device, a processor in the device executes the instructions for implementing the resource scheduling method according to the foregoing first aspect or second aspect.

The following further describes in detail the technical solutions of the present disclosure with reference to the accompanying drawings and embodiments.

### BRIEF DESCRIPTION OF DRAWINGS

The accompanying drawings constituting a part of the specification describe the embodiments of the present disclosure and are intended to explain the principles of the present disclosure together with the descriptions.

According to the following detailed descriptions, the present disclosure may be understood more clearly with reference to the accompanying drawings.

FIG. 1 is a schematic flowchart of a resource scheduling method provided in the embodiments of the present disclosure.

FIG. 2 is another schematic flowchart of a resource scheduling method provided in the embodiments of the present disclosure.

FIG. 3 is a schematic structural diagram of a resource scheduling device provided in the embodiments of the present disclosure.

FIG. 4 is still another schematic flowchart of a resource scheduling method provided in the embodiments of the present disclosure.

FIG. 5 is a schematic structural diagram of a server provided in the embodiments of the present disclosure.

FIG. 6 is a schematic structural diagram of a resource scheduling system provided in the embodiments of the present disclosure.

FIG. 7 is a schematic flowchart of an interactive process of a resource scheduling system provided in the embodiments of the present disclosure.

FIG. 8 is a schematic structural diagram of an application example of a resource scheduling system provided in the embodiments of the present disclosure; and

FIG. 9 is a schematic structural diagram of an electronic device, which may be a terminal device or a server, suitable for implementing the embodiments of the present disclosure.

### DETAILED DESCRIPTION

According to the resource scheduling methods, device and system, and the central server provided by the embodiments of the present disclosure, a first I/O request sent by a client device is received, a request number is assigned to the first I/O request based on a first number interval obtained from a central server, a tag of the first I/O request is determined based on the request number of the first I/O request, and the first I/O request is scheduled based on the tag of the first I/O request. The embodiments of the present disclosure solve the problem that resources are unevenly distributed and achieve the control of the number of I/O requests and the amount of concurrency according to a concurrency capability of a system by determining a tag by means of a request number and scheduling a first I/O request according to the tag.

Various exemplary embodiments of the present disclosure are now described in detail with reference to the accompanying drawings. It should be noted that: unless otherwise stated specifically, relative arrangement of the components and operations, the numerical expressions, and the values set forth in the embodiments are not intended to limit the scope of the embodiments of the present disclosure.

In addition, it should be understood that, for ease of description, the size of each part shown in the accompanying drawings is not drawn in actual proportion.

The following descriptions of at least one exemplary embodiment are merely illustrative actually, and are not intended to limit the present disclosure and the applications or uses thereof.

Technologies, methods and devices known to a person of ordinary skill in the art may not be discussed in detail, but such technologies, methods and devices should be considered as a part of the specification in appropriate situations.

It should be noted that similar reference numerals and letters in the following accompanying drawings represent similar items. Therefore, once an item is defined in an accompanying drawing, the item does not need to be further discussed in the subsequent accompanying drawings.

In order to improve a resource concurrency access capability, an object storage system generally deploys multiple gateway instances to provide storage service for a user. However, multiple gateway instances independently provide the storage service with no communication between each other. Therefore, it is very difficult to achieve effective control on the user, for example, scenarios for performing IOPS traffic limitation on the user, speed limitation and the like.

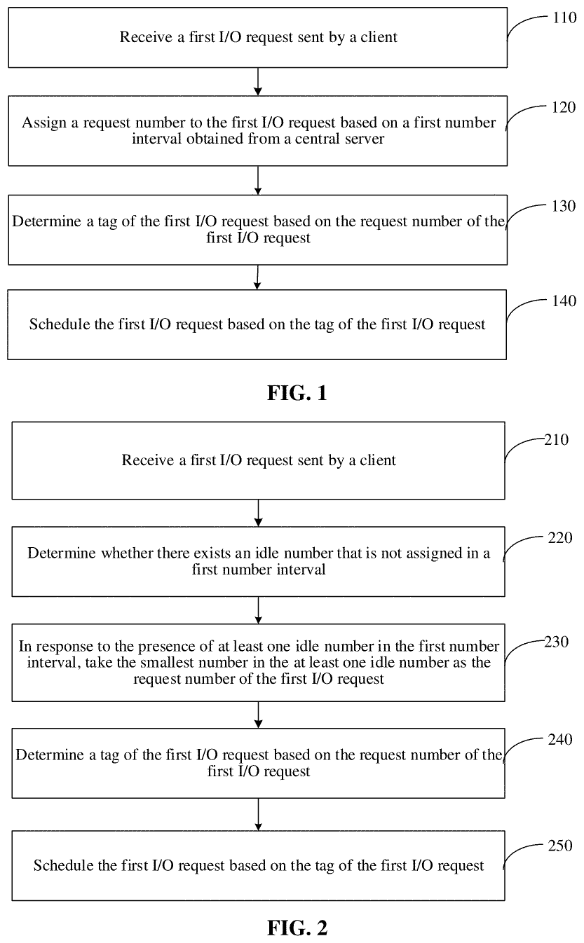

FIG. 1 is a schematic flowchart of a resource scheduling method provided in the embodiments of the present disclosure.

At operation 110, a first I/O request sent by a client device is received.

In some optional embodiments, the first I/O request may be sent by a client device, and the first I/O request may be used for requesting to perform an operation on resources. For example, the first I/O request may be sent by a user by means of the client device, and the first I/O request that is sent is used for requesting resources for the user, where the type of the operation requested in the first I/O request may include, but is not limited to, obtaining a file or other objects, querying a file or other objects, uploading a file or other objects and/or the like.

In an optional embodiment, after the first I/O request sent by the client device is received, the method may further include: analyzing at least one first I/O request, and obtaining user basic information corresponding to at least one client device sending the first I/O request based on the analysis result.

Each client device may correspond to at least one first I/O request. Optionally, the user basic information may include, but is not limited to, at least one of the following information: IP address information of the client device sending the first I/O request, a login identification (ID), a user name, a secret key, operation type information of the I/O request or the like.

In some optional embodiments, at least one first I/O request may be received by a load balancing software layer in a resource scheduling device, and according to load condition of the gateway instances and/or other factors, one of the gateway instances is selected to process the first I/O request. In this case, the gateway instance optionally obtains the user basic information by analyzing a header of a Hyper Text Transfer Protocol (HTTP) of the first I/O request. The purpose for obtaining the user basic information is to distinguish and analyze the first I/O request, and after resources corresponding to the first I/O request are obtained, the obtained resources are fed back according to IP address information in the user basic information, that is, the allocated resources are fed back to the client device corresponding to the IP address information of the first I/O request.

At operation 120, a request number is assigned to the first I/O request based on a first number interval obtained from a central server.

In some optional embodiments, each first I/O request corresponds to one request number.

In some optional embodiments, the request number is assigned to the first I/O request based on the central server. As an example, a first number interval is obtained from the central server, and the first number interval includes a set number of numbers, for example, 20 numbers included in the first number interval <21,40> are: number 21 to number 40. The first I/O request is numbered based on the numbers included in the first number interval, for example, one idle number (the idle number is a number that is not assigned) in the first number interval is assigned to one first I/O request. If there is currently no idle number in the first number interval, a local temporary number may be assigned as a request number of the first I/O request, for example, the assigned local temporary number equals to a request number assigned to the previous first I/O request plus 1. Meanwhile, optionally, a request is made to the central server for obtaining a new number interval, and after the new number interval is obtained, the numbers in the new number interval may be directly adopted to assign a request number to the first I/O request, so as to reduce the duration for waiting for the number and improve processing efficiency.

At operation 130, a tag of the first I/O request is determined based on the request number of the first I/O request.

In some optional embodiments, the tag of the first I/O request may be obtained by adopting an mClock algorithm. The mClock algorithm achieves effective control in multiple dimensions by combining a triple and corresponding scheduling. The triple (three tags), includes for example the following:

Reservation, specifies a limitation on an absolute value of performance to be reserved, for example, the Input/Output Operations Per Second (IOPS) are limited to be 250/s. This approach is a common strategy in the case that system bandwidth and IOPS are not overhead.

Limit: this limitation is also the limitation on the absolute value of the performance, for example, limiting the upper limit for use of IOPS, so as to, for example, prevent some 10 intensive applications from affecting online services, such as, for instance, anti-virus applications like virus scanners, applications for virtual-disk migrations, backup applications and/or the like.

Shares: the application and use for underlying resources are controlled by means of relative proportional control (weight).

According to the embodiments of the present disclosure, the tag of the first I/O request is determined by means of three tags, for example, the tag includes any one or more of a reservation tag (corresponding to Reservation), a limit tag (corresponding to Limit), and a weight tag (corresponding to Shares).

Different from using the mClock algorithm implementing control over the access of a Virtual Machine (VM) in the current cluster to a single backend service capability entity, the embodiments of the present disclosure achieve effective control in the foregoing three dimensions (corresponding to the three tags) over multiple backend service capability entities in a scenario where a user logins via multiple nodes.

At operation 140, the first I/O request is scheduled based on the tag of the first I/O request.

In some optional embodiments, the first I/O requests are sorted by means of the magnitudes of the tags corresponding to the first I/O requests, and the first I/O requests are scheduled according to the order. For example, the first I/O requests are sorted according to the tags from large to small, and the requested resources are allocated to the client devices sending the first I/O requests according to the order.

Based on the resource scheduling method provided in the foregoing embodiments of the present disclosure, a first I/O request sent by a client device is received; a request number is assigned to the first I/O request based on a first number interval obtained from a central server; a tag of the first I/O request is determined based on the request number of the first I/O request; and the first I/O request is scheduled based on the tag of the first I/O request; by determining the tag by means of the request number, and scheduling the first I/O request according to the tag, the problem that the resources are unevenly distributed is solved, and the control of the number of I/O requests and the amount of concurrency according to the concurrency capability of the system is achieved.

FIG. 2 is another schematic flowchart of a resource scheduling method provided in the embodiments of the present disclosure. As shown in FIG. 2, the method includes the following operations.

At operation 210, a first I/O request sent by a client device is received.

At operation 220, it is determined whether there exists an idle number that is not assigned in a first number interval.

In a scenario where a request number needs to be assigned to the first I/O request, it is firstly determined whether there exists an idle number that is not assigned in the first number interval obtained by the current device from a central server, where the idle number indicates a number in the first number interval, that is not assigned to a first I/O request as the request number, for example, the first number interval includes 20 numbers, and specifically includes <21,40>, after numbers 21-30 are all assigned to the first I/O requests as the request numbers, numbers 31-40 are idle numbers in the first number interval, and when one first I/O request is received, number 31 is assigned to the first I/O request as the request number.

At operation 230, in response to the presence of at least one idle number in the first number interval, the smallest number in the at least one idle number is taken as the request number of the first I/O request.

The first number interval includes the set number of numbers, where the value of each number is different, for example, the first number interval includes 20 numbers, and is specifically <21,40>, where the smallest number is 21, and the largest number is 40. Optionally, when being assigned to the first I/O requests, the numbers in the first number interval are assigned according to the values of the numbers in the order from small to large. For example, after numbers 21-30 in the forgoing example are assigned to the first I/O requests as the request numbers, numbers 31-40 are idle numbers in the first number interval, and when one first I/O request is received, number 31 is assigned to the first I/O request as the request number.

In some optional embodiments, if there is no idle number in the first number interval to be assigned to the first I/O request, a local temporary number is automatically assigned, for example, the assigned local temporary number equals to a request number assigned to the previous first I/O request plus 1. Meanwhile, a request is made to the central server for obtaining a new number interval, and after the new number interval is obtained, the numbers in the new number interval may be directly adopted to assign the request number to the first I/O request, so as to reduce the waiting time for number and improve the processing efficiency.

At operation 240, a tag of the first I/O request is determined based on the request number of the first I/O request.

In the embodiments of the present disclosure, the tag of the first I/O request may be obtained by means of the mClock algorithm, or the tag of the first I/O request is obtained in other manners based on the request number of the first I/O request. The embodiments of the present disclosure do not limit specific manners for obtaining the tag of the first I/O request.

At operation 250, the first I/O request is scheduled based on the tag of the first I/O request.

In the embodiments of the present disclosure, the request number is assigned to the first I/O request by means of the first number interval which is already obtained to the local, so as to obtain the request number quickly, perform resource allocation on each client device (user), and effectively control the number of user requests and the amount of concurrency.

In one or more optional embodiments, in operation 220, assigning the request number to the first I/O request based on the first number interval obtained from the central server includes: in response to the absence of the idle number in the first number interval, sending a number request for requesting a new number interval to the central server; and receiving a second number interval sent based on the number request by the central server, where the second number interval is spaced from the first number interval by at least one number interval.

In the embodiments of the present disclosure, in the case that no idle number exists in the first number interval, that is, all the numbers in the first number interval are assigned to the first I/O requests as the request numbers, if a first I/O request is further received, a number request for requesting a new number interval needs to be sent to the central server, and after the central server receives the number request, it sends a second number interval including a preset number of numbers to the resource scheduling device according to the number request. The second number interval is spaced from the first number interval by at least one number interval.

In some optional embodiments, in the waiting process of requesting to obtain the second number interval, in order to improve the processing efficiency, the resource scheduling device may assign a local temporary request number to the received first I/O request, and available space needs to be reserved for the local temporary request number, on this basis, in some embodiments of the present disclosure, at least one number interval is reserved between the second number interval and the first number interval as the number interval of the local temporary request numbers that can be assigned by the resource scheduling device.

In some optional embodiments, the method further includes the following operation: in response to the absence of the idle number in the first number interval, determining the request number of the first I/O request based on the largest number in the first number interval. For example, the first number interval is <21,40>, if all the numbers in the first number interval are assigned to the first I/O requests as the request numbers, and a first I/O request is further received, while a request for the second number interval is made to the central server, and it is determined that the request number assigned to the previous first I/O request is number 40, by adding 1 with number 40, number 41 is assigned to the newly received first I/O request as the local temporary request number (i.e., the request number of the first I/O request).

In some optional embodiments, the second number interval obtained from the central server may be <61,80>, and includes number 61 to number 80. Certainly, the second number interval in the embodiments is not limited thereto, and may also be <81,110> or the like.

In one or more optional embodiments of the present disclosure, operation 130 includes: determining the tag of the first I/O request based on a difference between the request number of the first I/O request and the request number of a second I/O request. The second I/O request is a previous I/O request sent by the client device corresponding to the first I/O request.

Optionally, in order to determine the tag corresponding to each first I/O request, a difference value of the request numbers of two first I/O requests needs to be respectively determined, that is, a difference between the request number corresponding to the second I/O request sent last time by the same client device and the request number corresponding to the first I/O request sent this time by the client device, then the tag of this first I/O request is calculated according to the difference, and the tag is calculated for the I/O request sent by the client device with the client device as a unit, so as to achieve the control of the number of the I/O requests for each client device, and reduce the problem that other client devices could not obtain resources due to the large number of requests from some client devices.

In some optional embodiments, determining the tag of the first I/O request based on the difference between the request number of the first I/O request and the request number of the second I/O request includes: determining the tag of the first I/O request based on the difference between the request number of the first I/O request and the request number of the second I/O request, the tag of the second I/O request, as well as the current time.

In some optional embodiments, the tag of the first I/O request includes, but is not limited to, at least one of a reservation tag, a limit tag, or a weight tag. The process for determining the tag of the first I/O request may include the following operations. The tag of the reservation tag corresponding to the first I/O request is obtained by means of calculation based on the difference between the request number of the first I/O request and the request number of the second I/O request, the tag of the second I/O request, a pre-stored tag value of the reservation tag corresponding to the client device, as well as the current time (the current time is the time when the first I/O request is obtained).

The tag value of the limit tag corresponding to the first I/O request is obtained by means of calculation based on the difference between the request number of the first I/O request and the request number of the second I/O request, the tag of the second I/O request, a pre-stored tag value of the limit tag corresponding to the client device, as well as the current time (the current time is the time when the first I/O request is obtained).

The tag value of the weight tag corresponding to the first I/O request is obtained by means of calculation based on the difference between the request number of the first I/O request and the request number of the second I/O request, the tag of the second I/O request, a pre-stored tag value of the weight tag corresponding to the client device, as well as the current time (the current time is the time when the first I/O request is obtained).

For example, the reservation tag, the limit tag, and the weight tag are obtained by adopting the following formulas:

$$\begin{matrix}{R}_{i}^{r} = max \{ {R}_{i}^{r - 1} + \frac{counter}{{r}_{i}} , t \} & Formula ( 1 ) \\ {L}_{i}^{r} = max \{ {L}_{i}^{r - 1} + \frac{counter}{{l}_{i}} , t \} & Formula ( 2 ) \\ {P}_{i}^{r} = max \{ {P}_{i}^{r - 1} + \frac{counter}{{p}_{i}} , t \} & Formula ( 3 )\end{matrix}$$

In the above formulas, Rᵢ^{r} represents the reservation tag of an r request (corresponding to the first I/O request) of an (i)^{th} client device, Lᵢ^{r} represents the limit tag of the r request (corresponding to the first I/O request) of the (i)^{th} client device, and Pᵢ^{r} represents the weight tag of the r request (corresponding to the first I/O request) of the (i)^{th} client device; rᵢ, lᵢ and pᵢ respectively indicate the pre-stored tag value of the reservation tag, the pre-stored tag value of the limit tag, and the pre-stored tag value of the weight tag corresponding to the (i)^{th} client device; t represents the current time; counter indicates the difference between the request numbers of the previous I/O request (corresponding to the second I/O request) and the current I/O request (corresponding to the first I/O request) of the (i)^{th} client device. The tag values of the three tags corresponding to each first I/O request may be obtained by means of the above formulas.

In one or more optional embodiments of the present disclosure, operation 140 includes: determining an order of the first I/O request in an I/O request queue based on the tag of the first I/O request; and scheduling the first I/O request based on the order of the first I/O request in the I/O request queue.

Optionally, scheduling the first I/O request based on the order of the tags may be implemented based on the following pseudo-code:

Algorithm: Components of Qos control algorithm in object storage

```
ApplyForCounter(client device cᵢ)
begin
if counter interval of cᵢ is used up
  activate counter interval apply thread
return counter difference between the current request and the last request
else
  return 1
end
Enqueue(request r, time t, client device cᵢ)
Begin
  counter = ApplyForCounter(client device cᵢ)
if cᵢ was idle then
/* Tag adjustment */
minPtag = minimum of all P tags;
foreach active cᵢ do
    Pᵢ^{r} −= minPtag − t;
/* Tag assignment */
${R}_{i}^{r} = max \{ {R}_{i}^{r - 1} + \frac{counter}{{r}_{i}} , t \} \text{/} \text{*} Reservation tag \text{*} \text{/}$
${L}_{i}^{r} = max \{ {L}_{i}^{r - 1} + \frac{counter}{{l}_{i}} , t \} \text{/} \text{*} Limit tag \text{*} \text{/}$
${P}_{i}^{r} = max \{ {P}_{i}^{r - 1} + \frac{counter}{{p}_{i}} , t \} \text{/} \text{*} Proportion tag \text{*} \text{/}$
end
dequeue(request r)
begin
Let E be the set of requests with R tag ≤ t
if E not empty then
/* constraint-based scheduling */
Select IO request with minimum R tag from E
else
/* weight-based scheduling */
Let E' be the set of requests with L tag ≤ t
If E' not empty then
Select IO request with minimum P tag from E'
      /* assuming request belong to client device vᵢ */
      Subtract 1/rₖ from R tags of client device vᵢ
end
```

In some optional embodiments of the present disclosure, the tag may include at least one of the reservation tag, the limit tag, or the weight tag, thus for the order of the first I/O request in the I/O request queue, at least one of the following is included: obtaining at least one first I/O request whose reservation tag is smaller than the current time, and sorting the obtained at least one first I/O request according to the reservation tag to obtain a first sequence; and obtaining at least one first I/O request whose the limit tag is smaller than the current time, and sorting the obtained at least one first I/O request according to at least one weight tag corresponding to the obtained at least one first I/O request to obtain a second sequence. The resources for the I/O request are further allocated to at least one first I/O request according to the first sequence and/or the second sequence.

For example, the first I/O requests are sorted according to the reservation tags from small to large to obtain the first sequence. For another example, for at least one first I/O request whose the limit tag is smaller than the current time, the at least one first I/O request is sorted according to the weight tag from small to large to obtain the second sequence.

In some optional embodiments of the present disclosure, allocating the resources for the I/O request to at least one first I/O request according to the first sequence and the second sequence includes: sequentially obtaining a preset number of first I/O requests from the first sequence, and allocating the requested resources to the preset number of first I/O requests according to the order of the preset number of first I/O requests in the first sequence; obtaining the order of the remaining first I/O requests in the first sequence in the second sequence, and allocating the requested resources to the preset number of first I/O requests according to the order of the preset number of first I/O requests in the second sequence.

Optionally, the backend service entity in the embodiments of the present disclosure implements the allocation of resources by adopting the mClock algorithm, the first sequence and/or the second sequence are obtained based on three tags, and the resources are allocated according to the first sequence and/or the second sequence. For example, the implementation is performed as follows.

The process of resource scheduling achieved using the mClock algorithm includes, but is not limited to the following several procedures: setting three dimensions of tags for the first I/O request, where the three dimensions of tags in some embodiments of the present disclosure include the reservation tag ri (corresponding to the Reservation tag), the limit tag li (corresponding to the Limit tag), and the weight tag wi (corresponding to the Share or weight tag).

Reservation: first, Reservation is preferentially guaranteed as best as it can, for example, ensuring that a certain client device can guarantee the IOPS to be 1w to support a training service. It should be noted that, in order to ensure that the Reservations of all the client devices can be guaranteed, a comprehensive resource capacity that can be provided by an underlying system is necessarily greater than the sum of the Reservations needs of all the client devices. Limit&Share (such as the weight tag described above): in the case of ensuring that the Limit is not exceeded, resource allocation is performed uniformly according to the Share proportion.

The scheduling of the first I/O request is achieved by combining tags in the three dimensions and the switching of schedulers.

The reason why Max is taken for the formulas (1), (2), and (3) is to avoid the phenomenon of idle integral for a client device in an idle status. For example, the previous I/O request is received very early, if an R value of the subsequent I/O request is:

$${R}_{i}^{r - 1} + \frac{1}{{r}_{i}} ,$$

it is obviously that it is easy to cause Rᵢ^{r} in some cases to be possibly far smaller than the current time (current-Time), and in terms of scheduling priority, the scheduler would preferentially schedule the I/O request having the minimum R value, which results in that the R values of I/O requests for other client devices, just switched from idle to active, are far larger than that of the previous client device, thereby causing starvation of the I/O request for the client device that is just switched to be active.

Limit&share: the larger the Limit tag is, the higher the density in the I/O request queue is, and the higher the occupation proportion is. However, it is ensured according to the priority of the share tag that I/O requests that do not exceed the Limit may be scheduled according to the share proportion.

In an optional example, the resource control method provided in the embodiments of the present disclosure may be implemented by combining the following several portions. The implementation portions may include, but are not limited to, an application layer (multi-machine multi-card training), a central server (which is responsible for managing the request numbers, each time a request of the gateway instance for the number is received, a continuous number interval is returned, such as, for example, <1,100>, <101,200> . . . ), a multi-gateway instance layer, a backend storage layer, and/or the like.

The process for implementing resource control by means of the foregoing several portions may include: the application layer is distributed training of a deep learning model, of which scenario may include one-machine multi-card and multi-machine multi-card, and is responsible for initiating an I/O request (corresponding to the first I/O request in the embodiments of the present disclosure); the I/O request reaches the load balancing software layer, and one of the gateway instances is selected, according to the load conditions of the gateway instances, to process the I/O request; the I/O request reaches the gateway instance, the gateway instance analyzes a http header of the I/O request to obtain user basic information, and determines whether an idle number exists currently; if there exists an idle number, it is requested to allocate one idle number to the I/O request as the request number; if there does not exist an idle number, a background thread responsible for initiating a number request is activated, and a number request is initiated to the central server to obtain a new number interval; in order to improve performance, in this case, the local temporary request number is directly assigned to the I/O request without waiting for the next batch of numbers to arrive; after the number is obtained, tagging operation (including at least one of the reservation tag, the limit tag, or the weight tag, carrying the corresponding tag values) is performed on the I/O request, and the I/O request is forwarded to an mClock order queue; the mClock order queue adjusts the order of the I/O requests in the queue according to the tags carried in the I/O request; after an I/O request processing thread pool obtains the I/O request from the mClock queue, the I/O request is analyzed, and is submitted to a background storage layer for execution according to the type of the I/O request; after the processing of the background storage layer is completed, a processing result is feedback to the object storage gateway instance, and the gateway instance feeds back the processing result to the program at the application layer.

A person of ordinary skill in the art may understand that all or some operations for implementing the foregoing method embodiments may be achieved by a program by instructing related hardware; the foregoing program can be stored in a computer readable storage medium; when the program is executed, operations including the foregoing method embodiments are executed. Moreover, the foregoing storage medium includes various media capable of storing program codes, such as ROM, RAM, a magnetic disk, or an optical disk.

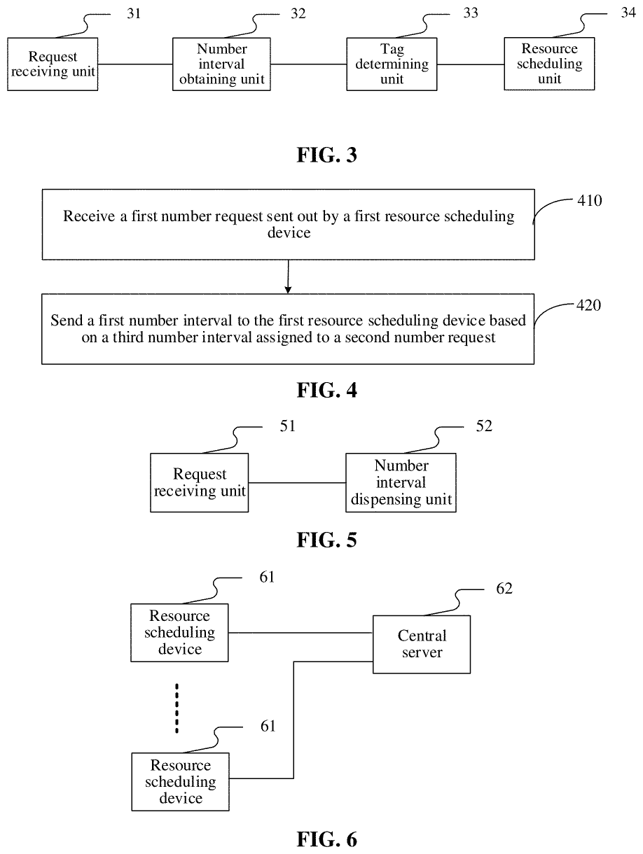

FIG. 3 is a schematic structural diagram of a resource scheduling device provided in the embodiments of the present disclosure. The device of the embodiments is configured to implement the foregoing method embodiments of the present disclosure. As shown in FIG. 3, the device of the embodiments includes:

a request receiving unit 31, configured to receive a first I/O request sent by a client device;

a number interval obtaining unit 32, configured to assign a request number to the first I/O request based on a first number interval obtained from a central server;

a tag determining unit 33, configured to determine a tag of the first I/O request based on the request number of the first I/O request; and

a resource scheduling unit 34, configured to schedule the first I/O request based on the tag of the first I/O request.

Based on the resource scheduling device provided in the foregoing embodiments of the present disclosure, the problem that the resources are unevenly distributed is solved and the control of the number of I/O requests and the amount of concurrency according to a concurrency capability of the system is achieved by determining the tag by means of the request number and scheduling the first I/O request according to the tag.

Optionally, the number interval obtaining unit 32 is configured to determine whether there exists an idle number that is not assigned in the first number interval; and in response to the presence of at least one idle number in the first number interval, take the smallest number in the at least one idle number as the request number of the first I/O request.

Optionally, the number interval obtaining unit 32 is configured to, in response to the absence of the idle number in the first number interval, send a number request to the central server for requesting a new number interval; and receive a second number interval sent based on the number request by the central server, where the second number interval is spaced from the first number interval by at least one number interval.

Optionally, the number interval obtaining unit 32 is configured to, in response to the absence of the idle number in the first number interval, determine the request number of the first I/O request based on the largest number in the first number interval.

In one or more optional embodiments, the tag determining unit 33 is configured to determine the tag of the first I/O request based on a difference between the request number of the first I/O request and the request number of a second I/O request. The second I/O is a previous I/O request sent by the client device corresponding to the first I/O request.

Optionally, in order to determine the tag corresponding to each first I/O request, a difference value of each first I/O request needs to be respectively determined, that is, a difference between the request number corresponding to the second I/O request sent last time by the same client device and the request number corresponding to the first I/O request sent this time by the client device, and then the tag of this first I/O request is calculated according to the difference, and the tag is calculated for the I/O request sent by a user with the user as a unit, so as to achieve the control of the number of the I/O requests corresponding to each client device, and reduce the problem that other users could not obtain resources due to the large number of requests from some users.

Optionally, the tag determining unit 33 is configured to determine the tag of the first I/O request based on the difference between the request number of the first I/O request and the request number of the second I/O request, a tag of the second I/O request, as well as the current time.

Optionally, the tag of the first I/O request includes at least one of a reservation tag, a limit tag, or a weight tag.

Optionally, the resource scheduling unit 34 is configured to determine an order of the first I/O request in an I/O request queue based on the tag of the first I/O request; and schedule the first I/O request based on the order of the first I/O request in the I/O request queue.

FIG. 4 is still another schematic flowchart of a resource scheduling method provided in the embodiments of the present disclosure, and the method may be applied to a server. As shown in FIG. 4, the method includes the following operations.

At operation 410, a first number request sent by a first resource scheduling device is received. The first number request is used for requesting the number interval for the client device.

Optionally, the first number request is an I/O request received by the first resource scheduling device from the client device, and the request number is required to be assigned to the received I/O request. Therefore, a request is required to be made to the central server to obtain a number interval, so as to achieve assigning the request number to the I/O request based on the obtained number interval, thereby achieving scheduling resources for the client device.

At operation 420, a first number interval is sent to the first resource scheduling device based on a third number interval assigned to the second number request. The second number request is a previous number request received by the central server and sent by a second resource scheduling device for the client device, and the first number interval is a number interval after the third number interval.

Optionally, the server provided in the embodiments of the present disclosure corresponds to multiple resource scheduling devices (for example, including the first resource scheduling device and the second resource scheduling device). After the third number interval is assigned to the second resource scheduling device sending the previous number request, when the first number interval is assigned to the first resource scheduling device currently sending out the number request, accumulation may be performed based on the third number interval so as to obtain a specific value range of the first number interval. For example, the third number interval is <1,20>, and the first number interval is <21,40>.

Optionally, the method may further include the following operation: before the first number interval is issued to the first resource scheduling device, further obtaining the total number of numbers of client devices corresponding to the resource scheduling device (including the first resource scheduling device), where the total number of numbers of the client devices may be determined based on information such as Quality of Service (QoS) of the client devices.

Optionally, the method may further include the following operation: after the total number of numbers of the client devices is obtained, determining the number of the numbers included in the first number interval sent to the first resource scheduling device according to the total number of the numbers of the client devices, that is, the number of the numbers in the first number interval sent to the first resource scheduling device this time is determined according to the total number of the numbers of the client devices, the number of the numbers of the sent first number interval is smaller than the total number of the numbers, so as to achieve effective control of the number of requests and the amount of concurrency according to the concurrency capability of the system and reduce the phenomena of system crashes and downtime due to high stress.

According to the resource scheduling method provided in the embodiments of the present disclosure, the first number request sent by the resource scheduling device is received by means of the server, the number interval including the preset number of numbers is sent to the resource scheduling device, so that the resource scheduling device assigns the request numbers to the I/O requests received by the resource scheduling device, so as to achieve resource scheduling for multiple resource scheduling devices.

A person of ordinary skill in the art may understand that all or some operations for implementing the foregoing method embodiments may be achieved by a program by instructing related hardware; the foregoing program can be stored in a computer readable storage medium; when the program is executed, operations including the foregoing method embodiments are executed. Moreover, the foregoing storage medium includes various media capable of storing program codes, such as ROM, RAM, a magnetic disk, or an optical disk.

FIG. 5 is a schematic structural diagram of a server provided in the embodiments of the present disclosure. The server of the embodiments is configured to implement the foregoing method embodiments of the present disclosure. As shown in FIG. 5, the server of the embodiments includes:

a request receiving unit 51, configured to receive a first number request sent by a first resource scheduling device, where the first number request is used for requesting a number interval for a client device;

a number interval issuing unit 52, configured to issue a first number interval to the first resource scheduling device based on a third number interval assigned to a second number request, where the second number request is a previous number request received by the server for the client device that is sent by a second resource scheduling device, and the first number interval is a number interval after the third number interval.

The server provided in the embodiments of the present disclosure receives the first number request sent by the resource scheduling device, the number interval including the preset number of numbers is issued to the resource scheduling device, so that the resource scheduling device assigns the request numbers to the I/O requests received by the resource scheduling device, so as to achieve resource scheduling for the multiple resource scheduling devices.

FIG. 6 is a schematic structural diagram of a resource scheduling system provided in the embodiments of the present disclosure. The resource scheduling system includes: multiple resource scheduling devices 61 and a central server 62, where

the resource scheduling device 61 is configured to send a first number request to the central server for requesting a number interval for a user;

the central server 62 is configured to send the first number interval to the resource scheduling device based on the first number request and a previous third number interval sent to the client device, where the first number interval is a number interval after the third number interval.

Optionally, the resource scheduling device 61 adopted in the embodiments of the present disclosure may be the resource scheduling device provided in any one of the foregoing embodiments, and may implement the resource scheduling method provided in the embodiments as shown in FIG. 1 or 2. The embodiments of the present disclosure do not limit the specific types of the resource scheduling device 61 and methods for applications thereof. According to the embodiments of the present disclosure, in order to achieve scheduling the I/O requests (for example, the first I/O requests) of the client devices by means of the resource scheduling device 61, the central server 62 is requested to obtain the number interval, and the client devices are numbered by means of the obtained number interval.

Optionally, the central server 62 adopted in the embodiments of the present disclosure may be the central server provided in any one of the foregoing embodiments, and may implement the resource scheduling method provided in the foregoing embodiments as shown in FIG. 3. The embodiments of the present disclosure do not limit the specific types of the central server 62 and methods for applications thereof.

Optionally, the numbers in the first number interval issued by the central server 62 this time for the client device are determined based on the numbers in the previous third number interval issued for the client device, for example, the obtained previous third number interval is <1,100>, and the first number interval obtained this time is <301,400>, the first number interval is a number interval after the third number interval, and the first number interval and the third number interval are not necessarily continuous. Based on the resource scheduling system provided in the foregoing embodiments of the present disclosure, in the manner of issuing a number interval for the resource scheduling device by means of the central server, the problem that it is difficult to achieve effective control over users due to the fact that multiple gateway instances independently provide storage services and are not communicated with each other is solved, and the control over the number of requests and the amount of concurrency for users can be achieved by means of the number interval and the problem that the resources are unevenly distributed is solved.

Optionally, the resource scheduling device 61 is further configured to: receive the first I/O request sent by the client device; assign the request number to the first I/O request based on the first number interval; and schedule the first I/O request based on the request number of the first I/O request.

Optionally, the resource scheduling device 61 is configured to determine a tag of the first I/O request based on the request number of the first I/O request; and schedule the first I/O request based on the tag of the first I/O request.

Optionally, the resource scheduling device 61 is configured to determine the tag of the first I/O request based on a difference between the request number of the first I/O request and the request number of a second I/O request, where the second I/O request is a previous I/O request sent by the client device corresponding to the first I/O request.

Optionally, the resource scheduling device 61 is further configured to determine the tag of the first I/O request based on the difference between the request number of the first I/O request and the request number of the second I/O request, the tag of the second I/O request, as well as the current time.

Optionally, the resource scheduling device 61 is configured to determine whether there exists an idle number that is not assigned in the first number interval; and in response to the presence of at least one idle number in the first number interval, take the smallest number in the at least one idle number as the request number of the first I/O request.

Optionally, the resource scheduling device 61 is configured to, in response to the absence of the idle number in the first number interval, send a second number request to the central server for requesting a new number interval; and receive the second number interval sent based on the second number request by the central server, where the second number interval is spaced from the first number interval by at least one number interval.

Optionally, the resource scheduling device 61 is further configured to, in response to the absence of the idle number in the first number interval, determine the request number of the first I/O request based on the largest number in the first number interval.

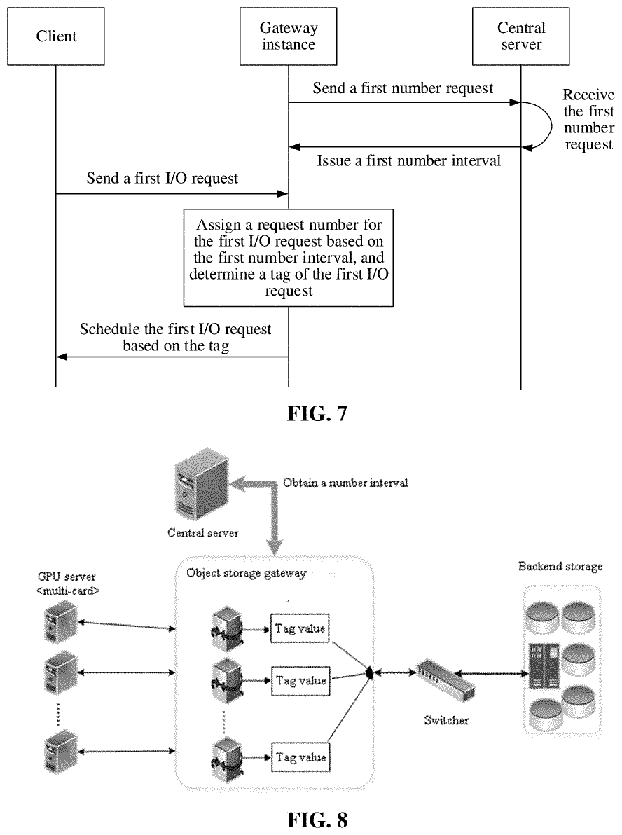

FIG. 7 is a schematic flowchart of an interactive process of a resource scheduling system provided in the embodiments of the present disclosure. As shown in FIG. 7, in the embodiments of the present disclosure, the resource scheduling device 61 may be the gateway instance.

In the embodiments, the resource scheduling system further includes the gateway instance receiving the first I/O request sent by the client device. An interactive process of the client device, the gateway instance, and the central server includes: the gateway instance sends the first number request for requesting the number interval for the client device, and sends the first number request to the central server; the central server determines the first number interval based on the first number request and the previous third number interval issued for the client device, and feeds back the first number interval to the gateway instance; the gateway instance receives the first number interval; the client device sends the first I/O request to the gateway instance; the gateway instance receives the first I/O request; the request number is assigned to the first I/O request based on the first number interval, the tag of the first I/O request is determined based on the assigned request number, and the scheduling for the first I/O request is achieved based on the tag of the first I/O request.

FIG. 8 is a schematic structural diagram of an application example of a resource scheduling system provided in the embodiments of the present disclosure. As shown in FIG. 8, a user submits one-machine multi-card and multi-machine multi-card tasks and initiates an I/O request, and after an object storage gateway (corresponding to the resource scheduling device) receives the I/O request, it is determined whether numbers in the current number interval are assigned completely (i.e., whether an idle number is further included); if the idle number exists, one number is obtained as a request number of the I/O request (the request number of the current I/O request may be adding 1 by the number of the previous I/O request); if the idle number does not exist, a background thread is activated to send a number request to the central server to obtain a new number interval (the number interval obtained at this time and the obtained previous number interval are not necessarily continuous, for example, the previous interval is <1,100>, and the interval obtained now is <301,400>), and a local temporary request number is assigned to the I/O request as the request number; the mClock algorithm may be adopted, for example, a tag (at least one tag of the reservation tag, the limit tag, or the weight tag) is obtained according to at least one formula of formulas (1), (2), and (3), and the tag is carried in the I/O request in the manner of “tagging”.

The I/O requests that are “tagged completely” are pushed to a request queue, and are sorted according to the tags; the I/O request processing thread pool obtains the I/O requests from the request queue according to the order result, and submits the I/O requests to the background storage layer (i.e., backend storage in FIG. 8) for processing, and the background storage layer feeds back the execution result to the application layer after processing completely.

The embodiments of the present disclosure further provide an electronic device, including: a memory, configured to store executable instructions; and a processor, configured to communicate with the memory to execute the executable instructions so as to complete the operations of the resource scheduling method provided according to any one of the foregoing embodiments.

The embodiments of the present disclosure further provide a computer readable storage medium, configured to store computer readable instructions, where when the instructions are executed, the operations of the resource scheduling method provided according to any one of the foregoing embodiments are executed.

The embodiments of the present disclosure further provide a computer program product, including a computer readable code, where when the computer readable code runs in a device, a processor in the device executes the instructions for implementing the resource scheduling method provided according to any one of the foregoing embodiments.

The computer program product is specifically implemented by means of hardware, software, or a combination thereof. In one optional example, the computer program product is specifically represented by a computer storage medium. In another optional example, the computer program product is specifically represented by a software product, such as a Software Development Kit (SDK).

It should be understood that the terms such as “first” and “second” in the embodiments of the present disclosure are only used for distinguishing, and shall not be understood as limitations on the embodiments of the present disclosure.

It should be further understood that in the embodiments of the present disclosure, “a plurality of” may refer to two or more, and “at least one” may refer to one, two, or more.

It should be further understood that any component, data, or structure mentioned in the embodiments of the present disclosure should be generally understood as one or more under the condition that no explicit definition is provided or no opposite motivation is provided in the context.

It should be further understood that the description of the embodiments of the present disclosure emphasizes differences between the embodiments, and the same or similar points therebetween may be used as reference and omitted for clarity.

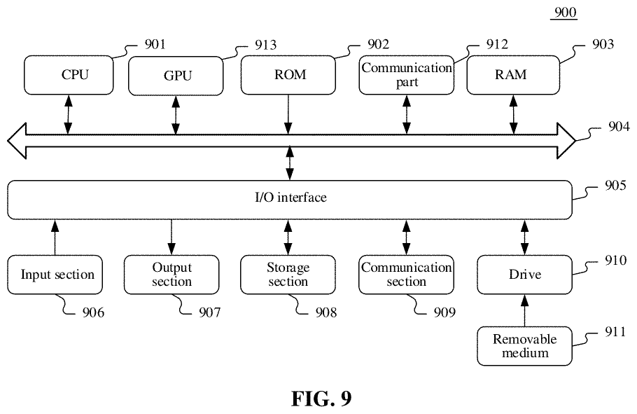

Embodiments of the present disclosure further provide an electronic device which, for example, may be a mobile terminal, a Personal Computer (PC), a tablet computer, a server, and the like. Referring to FIG. 12 below, a schematic structural diagram of an electronic device 800, which is a terminal device or a server, suitable for implementing the embodiments of the present disclosure is shown. As shown in FIG. 9, the electronic device 900 includes one or more processors, a communication part, or the like. The one or more processors are, for example, one or more Central Processing Units (CPUs) 901 and/or one or more Graphic Processing Units (GPUs) 913, and may execute appropriate actions and processing according to executable instructions stored in a Read Only Memory (ROM) 902 or executable instructions loaded from a storage section 908 to a Random Access Memory (RAM) 903. A communication part 912 may include, but is not limited to, a network card. The network card may include, but is not limited to, an Infiniband (IB) network card.

The processor may be communicated with the ROM 902 and/or RAM 903 to execute the executable instructions and is connected to the communication part 912 by means of a bus 904 and communicated with other target devices by means of the communication part 912, so as to complete the operations corresponding to any of the methods provided in the embodiments of the present disclosure, for example, a first I/O request sent by the client device is received; a request number is assigned to the first I/O request based on a first number interval obtained from a central server; a tag of the first I/O request is determined based on the request number of the first I/O request; the first I/O request is scheduled based on the tag of the first I/O request; the tag is determined by means of the request number, and the first I/O request is scheduled according to the tag.

In addition, the RAM 903 further stores various programs and data required for operations of an apparatus. The CPU 901, the ROM 902, and the RAM 903 are connected to each other via the bus 904. In the presence of the RAM 903, the ROM 902 is an optional module. The RAM 903 stores executable instructions, or writes the executable instructions into the ROM 902 during running, where the executable instructions cause the CPU 901 to execute corresponding operations of the foregoing communication method. An I/O interface 905 is also connected to the bus 904. The communication part 912 may be integrated, or may be configured to have multiple sub-modules (for example, multiple IB network cards) connected to the bus.

The following components are connected to the I/O interface 905: an input section 906 including a keyboard, a mouse and the like; an output section 907 including a Cathode Ray Tube (CRT), a Liquid Crystal Display (LCD), a speaker and the like; a storage section 908 including a hard disk and the like; and a communication section 909 of a network interface card including an LAN card, a modem and the like. The communication section 909 performs communication processing via a network such as the Internet. A drive 910 is also connected to the I/O interface 905 according to requirements. A removable medium 911 such as a magnetic disk, an optical disk, a magneto-optical disk, a semiconductor memory or the like is installed on the drive 910 according to requirements, so that a computer program read from the removable medium is installed on the storage section 908 according to requirements.

It should be noted that the architecture illustrated in FIG. 9 is merely an optional implementation mode. During specific practice, the number and types of the components in FIG. 9 are selected, decreased, increased, or replaced according to actual requirements. Different functional components are separated or integrated or the like. For example, the GPU 913 and the CPU 901 are separated, or the GPU 913 is integrated on the CPU 901, and the communication part is separated from or integrated on the CPU 901 or the GPU 913 or the like. These alternative implementations all fall within the scope of protection of the embodiments of the present disclosure.

Particularly, a process described above with reference to a flowchart according to the embodiments of the present disclosure may be implemented as a computer software program. For example, the embodiments of the present disclosure include a computer program product, including a computer program tangibly included on a machine readable medium; the computer program includes program codes for executing the method shown in the flowchart; the program codes may include corresponding instructions for executing operations of the method provided in the embodiments of the present disclosure, for example, a first I/O request sent by a client device is received; a request number is assigned to the first I/O request based on a first number interval obtained from a central server; a tag of the first I/O request is determined based on the request number of the first I/O request; the first I/O request is scheduled based on the tag of the first I/O request; and the tag is determined by means of the request number, and the first I/O request is scheduled according to the tag. In such embodiments, the computer program is downloaded and installed from the network by means of the communication section 909, and/or is installed from the removable medium 911. When the computer program is executed by the CPU 901, the operations of functions defined in the method according to the present disclosure are executed.

The methods and apparatuses of the present disclosure are implemented in many manners. For example, the methods and apparatuses of the present disclosure are implemented by means of software, hardware, firmware, or any combination of software, hardware, and firmware. Unless otherwise specially stated, the foregoing sequences of operations of the methods are merely for description, and are not intended to limit the operations of the methods of the present disclosure. In addition, in some embodiments, the present disclosure may also be implemented as programs recorded in a recording medium. The programs include machine-readable instructions for implementing the methods according to the present disclosure. Therefore, the present disclosure further covers the recording medium storing the programs for executing the methods according to the present disclosure.

The descriptions of the present disclosure are provided for the purpose of examples and description, and are not intended to be exhaustive or limit the present disclosure to the disclosed form. Many modifications and changes are obvious to a person of ordinary skill in the art. The embodiments are selected and described to better describe a principle and an actual application of the present disclosure, and to enable a person of ordinary skill in the art to understand the present disclosure, so as to design various embodiments with various modifications applicable to particular use.

1. A resource scheduling method, comprising:
receiving a first Input/Output (I/O) request sent by a client device;
assigning a request number to the first I/O request based on a first number interval obtained from a central server;
determining a tag of the first I/O request based on the request number of the first I/O request; and
scheduling the first I/O request based on the tag of the first I/O request.

2. The method according to claim 1, wherein assigning the request number to the first I/O request based on the first number interval obtained from the central server comprises:
determining whether there exists an idle number that is not assigned in the first number interval; and
in response to the presence of at least one idle number in the first number interval, taking the smallest number in the at least one idle number as the request number of the first I/O request.

3. The method according to claim 1, wherein assigning the request number to the first I/O request based on the first number interval obtained from the central server comprises:
in response to the absence of an idle number in the first number interval, sending a number request to the central server for requesting a new number interval; and
receiving a second number interval sent based on the number request by the central server, wherein the second number interval is spaced from the first number interval by at least one number interval.

4. The method according to claim 1, wherein assigning the request number to the first I/O request based on the first number interval obtained from the central server comprises:
in response to the absence of an idle number in the first number interval, determining the request number of the first I/O request based on the largest number in the first number interval.

5. The method according to claim 1, wherein determining the tag of the first I/O request based on the request number of the first I/O request comprises:
determining the tag of the first I/O request based on a difference between the request number of the first I/O request and a request number of a second I/O request, wherein the second I/O request is a previous I/O request sent by the client device corresponding to the first I/O request.

6. The method according to claim 5, wherein determining the tag of the first I/O request based on the difference between the request number of the first I/O request and the request number of the second I/O request comprises:
determining the tag of the first I/O request based on the difference between the request number of the first I/O request and the request number of the second I/O request, a tag of the second I/O request, as well as a current time.

7. The method according to claim 1, wherein the tag of the first I/O request comprises at least one of a reservation tag, a limit tag, or a weight tag.

8. The method according to claim 1, wherein scheduling the first I/O request based on the tag of the first I/O request comprises:
determining an order of the first I/O request in an I/O request queue based on the tag of the first I/O request; and
scheduling the first I/O request based on the order of the first I/O request in the I/O request queue.

9. A resource scheduling device, comprising:
a memory, configured to store executable instructions; and
a processor, configured to communicate with the memory to execute the executable instructions, when the executable instructions are executed by the processor, the processor is configured to:
receive a first I/O request sent by a client device;
assign a request number to the first I/O request based on a first number interval obtained from a central server;
determine a tag of the first I/O request based on the request number of the first I/O request; and
schedule the first I/O request based on the tag of the first I/O request.

10. A resource scheduling system, comprising: multiple resource scheduling devices and a central server, wherein
the resource scheduling device is configured to send out a first number request for requesting a number interval for a client device to the central server;
the central server is configured to send a first number interval to the resource scheduling device based on the first number request and a previous third number interval issued for the client device, wherein the first number interval is a number interval after the previous third number interval.

11. The system according to claim 10, wherein the resource scheduling device is further configured to:
receive a first I/O request sent by the client device; assign a request number to the first I/O request based on the first number interval; and schedule the first I/O request based on the request number of the first I/O request.

12. The system according to claim 11, wherein the resource scheduling device is configured to determine a tag of the first I/O request based on the request number of the first I/O request; and schedule the first I/O request based on the tag of the first I/O request.

13. The system according to claim 10, wherein the resource scheduling device is configured to determine a tag of a first I/O request based on a difference between a request number of the first I/O request and a request number of a second I/O request, wherein the second I/O request is a previous I/O request sent by the client device corresponding to the first I/O request.

14. The system according to claim 13, wherein the resource scheduling device is further configured to determine the tag of the first I/O request based on the difference between the request number of the first I/O request and the request number of the second I/O request, the tag of the second I/O request, as well as a current time.

15. The system according to claim 11, wherein the resource scheduling device is configured to determine whether there exists an idle number that is not assigned in the first number interval; and in response to the presence of at least one idle number in the first number interval, take the smallest number in the at least one idle number as the request number of the first I/O request.

16. The system according to claim 10, wherein the resource scheduling device is configured to, in response to the absence of an idle number in the first number interval, send a second number request to the central server for requesting a new number interval; and receive a second number interval sent based on the second number request by the central server, wherein the second number interval is spaced from the first number interval by at least one number interval.

17. The system according to claim 15, wherein the resource scheduling device is configured to, in response to the absence of the idle number in the first number interval, determine the request number of the first I/O request based on the largest number in the first number interval.

18. The system according to claim 10, wherein the resource scheduling device is a gateway instance.

19. A non-transitory computer readable storage medium, configured to store computer readable instructions, wherein when the computer readable instructions are executed, the operations of the resource scheduling method according to claim 1 are performed.
